(19) United States
(12) Patent Application Publication
(10) Pub. No.: US 2014/0278887 A1
(43) Pub. Date: Sep. 18, 2014

(54) REWARDS REDEMPTION SYSTEM AND METHOD (CPG/OEM LOYALTY PROGRAM)

(71) Applicant: Maritz Holdings Inc., Fenton, MO (US)

(72) Inventor: Carlo Pirillo, Mississauga (CA)

(73) Assignee: Maritz Holdings Inc., Fenton, MO (US)

(21) Appl. No.: 14/205,672

(22) Filed: Mar. 12, 2014

Related U.S. Application Data
(60) Provisional application No. 61/776,933, filed on Mar. 12, 2013.

(51) Int. Cl. G06Q 30/02; G06Q 20/36

(52) U.S. Cl. CPC G06Q 30/0226; G06Q 30/0238; G06Q 20/36
USPC 705/14.27

(57) ABSTRACT

Customers making purchases via a mobile payments method involving an electronic receipt (ereceipt) will be provided the option to participate in a direct to consumer CPG\OEM program. A module within their mobile wallet will detect new receipts and submit them to the CPG\OEM Coalition Loyalty System. Once submitted to the CPG\OEM Coalition Loyalty System, ereceipts will be decomposed and purchased items within the ereceipt will be associated to individual CPGs\OEMs. Purchased items identified to individual participating CPG\OEM loyalty programs will have associated action invoked (e.g., discount, awarding of points or other marketing activities).

### CROSS-REFERENCE TO RELATED APPLICATIONS

This application is a nonprovisional patent application which claims the benefit of U.S. Provisional Patent Application Ser. No. 61/776,933 filed Mar. 12, 2013, the entire disclosure of which is incorporated by reference.

### BACKGROUND

The present invention generally relates to systems and methods for allowing customers to participate in loyalty programs directly with Consumer Package Goods (CPG) or Original Equipment Manufacturer (EOM). In particular, the present invention relates to the collection and aggregation of Point of Sale (POS) transactions via a mobile wallet and electronic receipts.

Previous attempts by CPG\OEM to execute direct to consumer programs have resulted in less than optimal results due to a burden on the consumer to provide “proof of purchase” and/or an inability to consistently and comprehensively link the submitted “proof of purchase” with a specific individual and in some cases a validated purchase.

### SUMMARY

A CPGs\OEMs loyalty program allows members to easily participate in loyalty constructs that are being executed directly by CPGs\OEMs. The solution also provides the ability for CPGs\OEMs to execute loyalty programs directly with their customers. Customers making purchases via a mobile payments method involving an electronic receipt (ereceipt) will be provided the option to participate in a direct to consumer CPG\OEM program. Once customers ‘opt in’ to the program and agree to terms, there is no ongoing manual effort required on their part. To participate, customers agree to share their ereceipt data. A module within their mobile wallet will detect new receipts and submit them to the CPG\OEM Coalition Loyalty System. Once submitted to the CPG\OEM Coalition Loyalty System, ereceipts will be decomposed and purchased items within the ereceipt will be associated to individual CPGs\OEMs. Purchased items identified to individual participating CPG\OEM loyalty programs will have associated action invoked (e.g., discount, awarding of points or other marketing activities). The aggregation of POS data from various retailers into a form enables an administrator of the control center to approach non-participating CPGs\OEMs.

### BRIEF DESCRIPTION OF THE DRAWINGS

FIG. 1 is a block diagram of a system.

FIG. 2 is an illustration of some of the various components and their interaction according to one embodiment of the system.

FIG. 3 illustrates the process of initially downloading and setting up on a mobile device an application according to one embodiment of the system.

### DETAILED DESCRIPTION

FIG. 1 is an illustration of one embodiment of various hardware and software components of the invention. In this configuration, a system 500 of the invention includes a mobile device 502 having an NFC (near field communication) chip 504 which permits secure transactions via embedded NFC terminals 505 of retailers 508. Within the mobile device 502, a mobile wallet 521 will provide a ‘container’ for credit and debit cards, and a storage memory 544 for storing the electronic receipts associated with the purchases made through NFC terminals 505 with retailers 508.

A CPG\OEM Coalition Loyalty control center 530 interfaces with a CPG/OEM loyalty application 523 (e.g., an APP) which resides on and is executed by the mobile device 502. In one embodiment, the APP 523 may interface with the mobile wallet 521 so that the APP 523 includes an ereceipt aggregation module 522, which interfaces with the CPG\OEM control center 530, as indicated by arrow 553. In another embodiment, a widget is included with or added to the mobile wallet 521 so that the mobile wallet 521 and its storage memory 544 interface with the control center 530, as indicated by arrow 555, and in addition, the APP 523 also interfaces with the control center 530 as indicated by arrow 553.

In one form, the control center 530 is a server which contains a raw receipt database 532 of receipts received directly from the mobile wallet 521 or received via the APP 523, as noted above. The control center 530 also includes a CPG\OEM product database 536 of products sold by the CPG/OEM partners which are part of the coalition of partners implementing a loyalty program via the system 500. The control center 530 also includes a member and loyalty program database 533 listing all programs and the members 115 which have “opted in” each program. The control center 530 also includes a rationalized receipt database 537 of the ereceipts which have (1) stored in the raw receipt database 532, (2) decomposed by a receipt decomposer 535, (3) rationalized by a rationalization engine 538, and (4) stored in the rationalized receipt database 537. The control center 530 also includes a CPG\OEM Loyalty module interface 534 for facilitating communication between the control center 530 and the APP 522 via gateway 531.

Initially, a member 115 must agree or “opt in” to allowing the mobile wallet 521 and/or the APP 523 access to the member's ereceipts stored in memory 544 so that copies of the ereceipts can be provided to the control center 530. After this initial “opt in,” all collected receipt data stored in the memory 544 within the mobile wallet 521 are submitted to the CPG\OEM coalition loyalty control center 530 via a gateway 531 and via the CPG\OEM Loyalty module interface 534. The submitted receipts are decomposed into their unique data items by the receipt decomposer 535. Each individual purchased line item is compared to product items within the products database 536 to identify the CPG\OEM associated with the line item, classified (if possible) and stored within the rationalized receipt database 537, by the rationalization engine 538.

The control center 530 compares each purchased line item to products stored in the product database 536. When a match is found corresponding to a purchased product which is part of a new CPG/OEM program in which the member is not yet participating, the member 115 is offered a second “opt in” opportunity to become part of this new program. Once a member has ‘opted in’ to a program and accepted the terms, all future collected receipt data stored in the ereceipts memory 544 within the mobile wallet 521 are submitted to the CPG\OEM coalition loyalty control center 530 via a gateway 531 and via the CPG\OEM Loyalty module interface 534. As noted above, the ereceipts may be submitted to the control center 530 directly by the mobile wallet or from the ereceipts memory 544 of the mobile wallet 521 via the APP 523 to the control center 530.

The submitted receipts are decomposed into their unique data items by the receipt decomposer 535. Each individual purchase line item is compared to product items within the products database 536 to identify the CPG\OEM associated with the line item, classified (if possible) and stored within the rationalized receipt database 537, by the rationalization engine 538.

A CPG\OEM Program Management module 545 then applies the appropriate business rules for each participating CPG\OEM, which is stored in the member and loyalty program database 533. The module 545 may be part of the control center 530 or remote and separate from the control center 530, as illustrated. For example, a customer purchases products and/or services using his mobile wallet 521 which stores a receipt in memory 544. The receipt is transferred to the control center 530, where it is decomposed and item 4 is identified as a product from CPG 541E who is a participating partner. The business rules stored in database 533 indicate that this product is worth “3 points” to a customer. As a result, the management module implements the storage of 3 points within the customer's account.

Within the same transaction, the CPG\OEM loyalty module interface 534 identifies that an upsell offer is also associated with one of the product purchases listed on the ereceipt and pushes out a special offer to the customer.

As new CPG\OEM partners 541 come on board to the existing coalition of programs and CPG/OEM partners, the newly available programs are pushed out to the loyalty application 523 indicating to the member 115 that a new program is available. Via the APP 523, the member is questioned to determine whether the member would like to participate in each new program. If the member opts in, the new CPG\OEM partner is added to the programs to which the member is eligible, as stored in the member and loyalty program database 533.

FIG. 2 is an illustration of some of the various components and their interaction according to one embodiment of the invention. In particular, FIG. 2 illustrates one configuration of a CPG\OEM Loyalty system 500 for implementing the collection, aggregation and decomposition of ereceipt data for the purpose of enabling direct to consumer loyalty program for CPGs/OEMs.

The mobile device 502 includes a mobile wallet ereceipt aggregation module 521, a Maritz CPG\OEM Loyalty Application (APP) 523 and a near-field communication (NFC) or other mobile payments protocol 521, each of which may be an embedded part of the device 502 or may be a software application (e.g., an “APP”) which is downloaded and installed into the device 502. The NFC protocol communicates with a retailer's point-of-sale terminal 505 which effects purchase transactions of a retailer 508. In some forms, the APP 523 lists participating individual program 112 so that the member 115 is aware of their programs. This program information may also be communicated to the control center 530 to assist the control center in analyzing the member's ereceipts.

The program component includes a CPG\OEM Loyalty control center 530 which is an interface for communicating with individual participating program owners 541 via an aggregated data gateway 531 (e.g., a server). The CPG\OEM Coalition Loyalty control center 530, and the CPG\OEM Coalition loyalty controls center gateway 531 may be part of a single server (e.g. a single processor) executing software, or separate components (e.g., separate processors) executing separate software programs, as illustrated.

### Initial Application Download and Setup

FIG. 3 illustrates the process of initially downloading and setting up on a mobile device an application according to one embodiment of the invention. The following also refers to FIGS. 1 and 2.

Initially, a program member 115 downloads at 302 a CPG\OEM mobile Loyalty application 523 to their mobile device 502 which is mobile payments ready (can support NFC or equivalent mobile payments protocol 504). The application 523 comprises processor executable instructions fixed in a tangible storage media. As part of this download process, a mobile wallet widget or application 521 is also downloaded and installed onto the device 502 of the member 115. Frequently, the application 523 is a software program stored at and available from a server. For example, a copy of the application 523 may stored on and transferred from the CPG\OEM Coalition Loyalty Control Center 530 to the mobile device 502 where it is installed, stored and executed.

The program member 115 via the mobile CPG\OEM loyalty application 523 logs IN to connect to the control center 530 and responds to an authentication request at 113. If the request is confirmed at 119, the device is authenticated through a CPG\OEM Coalition Loyalty control center 530 which is part of the system 500 operated by an administrator 567 (see FIG. 1). Once authenticated, the member 115 initially agrees to OPT IN and shares their ereceipts. Thereafter, a list of participating partners is uploaded 116 to the CPG\OEM Loyalty application 523. The list of partners may in part be based on the previous ereceipt transactions which have been provided to the control center 530 after the member initially OPTS IN and shares their ereceipts.

The CPG\OEM Coalition Loyalty Systems includes a CPG\OEM Coalition Loyalty control center 530, which manages active programs and the collection, decomposition and rationalization of ereceipt data from participating members. Via 112 and the APP 523, members 115 are presented an updated list of available programs in which they can opt to participate. And/or via 115-117, members 115 are presented an updated requests of available programs in which they are invited to participate based on their previous ereceipt transactions which have been provided to the control center 530. Member are required to ‘opt’ in and permit the ereceipt aggregation module 521 to collect, submit and share their receipt data 544 with the CPG\OEM Coalition loyalty control center 530. This receipt data will be collected by the NFC payments process and stored within the mobile devices mobile wallet 521. Items for both participating and non-participating CPGs\OEMs will be consumed and analyzed. Each new receipt that is submitted into a participating member's mobile wallet 521 is collected by the ereceipt aggregation module 521 and submitted to the CPG\OEM Coalition loyalty control center 530.

The collected receipt data will be decomposed by the decomposer 535 of the CPG\OEM Coalition Loyalty Control Center 530. This decomposition will include such parsing as the separation of individual line items into description and cost, the retailer of purchase, the location and the date and time of the transaction. The CPG\OEM Coalition loyalty control center 530 will utilize a products database 536 to identify and classify items specific to individual CPGs\OEM partners 541. Once decomposed and transformed, specific CPG\OEM purchase data will be available to the participating member 115.

Collected, decomposed and rationalized receipt data for purchased items not covered by a program will be available to the program administrator 567. This information allows the administrator 567 to conduct new partner prospecting and recruitment by contacting non-participating CPGs\OEMs for the purpose of joining a coalition (e.g., becoming part of system 500) and becoming a new partner 541.

### CPG\OEM Loyalty Coalition Process

When the member 115 via their mobile device 521 initially opens the CPG\OEM coalition loyalty program application 523 after downloading to the mobile device 521, an authentication request 113 is submitted to the CPG\OEM coalition loyalty program control center 530. The CPG\OEM coalition loyalty program APP 523 stores participating member data and associated authentication information within its CPG\OEM coalition loyalty database 533.

Upon successful authentication confirmation, the CPG\OEM Loyalty Application 523 requests an update of the participating CPG\OEM loyalty programs 121 from the CPG\OEM Coalition loyalty control system 530. The CPG\OEM coalition loyalty program APP 523 returns a list of the programs 116 to the CPG\OEM Loyalty program APP 523 and an update to programs 112 to the ereceipt Aggregation Module 521 which the member is participating in. With the updated list of programs, the CPG\OEM Coalition Loyalty APP 523 displays the list of programs, earned value or credits and pushed messages to the member 115.

Participating members 115 can see, via the CPG\OEM loyalty program APP 523 on their mobile device 502, their program status including earned credits, points or other currencies, targeted offers and communications from the individual program owners 541.

New CPG\OEM programs can be launched by the administrator 567, stored in the database 533 and managed via the CPG\OEM program management module 545, which dictates valid products and the associated benefit for the purchase of such products. The CPG\OEM program management module 545 also manages all push communications to individual members 115.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

1. A system comprising:
a mobile device of a user;
a mobile wallet stored on the mobile device and executed by the mobile device to transact electronic purchases of items, wherein the mobile wallet stores ereceipts of each purchase on the mobile device;
a control center to implement at least one loyalty program of a partner;
a loyalty APP stored on the mobile device and executed by the mobile device to facilitate communication between the user and the control center via the mobile device, the loyalty APP to allow the user to coordinate the user's involvement in the loyalty program;
wherein the mobile wallet or the loyalty APP provides the stored ereceipts to the control center;
wherein the control center evaluates the provided ereceipts to identify purchased items;
wherein the control center determines purchased items which quality under the loyalty program; and
wherein the control center implements the loyalty program in response to the qualified items.

2. The system of claim 1 wherein the purchased items which qualify under the loyalty program will have an associated action (e.g., discount, awarding of points, other marketing activities) and wherein the control center implements the associated action.

3. The system of claim 1 wherein the loyalty APP allows the user to coordinate the user's involvement in the loyalty program as follows:
authorizing the transfer of ereceipts from the mobile wallet to the control center;
allowing the user to join or withdraw from the loyalty program; and
allowing the user to check their status within the loyalty program.

4. The system of claim 1 wherein the control center implements a plurality of loyalty programs of a plurality of partners.

5. The system of claim 3 wherein the mobile device includes an NFC chip, wherein the mobile wallet includes a widget to interface with the control center, and wherein the mobile wallet employs an NFC protocol to transact electronic purchases of items with an NFC terminal of a retailer.

6. The system of claim 1 wherein the mobile wallet or the loyalty APP include an aggregation module storing the ereceipts and providing the ereceipts to the control center.

7. The system of claim 1 wherein the control center comprises at least one of the following:
a receipts database storing received ereceipts;
a product data of products which are part of the loyalty program;
a member database of members of the loyalty program;
a loyalty database of rules of the loyalty program;
a rationalized receipts database of received ereceipts which been rationalized;
a rationalization engine for rationalizing ereceipts;
a receipt decomposer for decomposing the ereceipts;
a management module for use by an administrator to manage the loyalty program;
a module interface for interfacing between a rationalized receipts database and the loyalty APP; and
a gateway for providing access to the control center by which the following have access: an administrator, the partner, the mobile wallet and the loyalty APP.

8. The system of claim 1 wherein the control center notifies the user of a new program and provides the option for the user to participate in the new program.

9. The system of claim 1 wherein the control center identifies an additional program for which the user qualifies based on one of the purchased items in one of the ereceipts provided to the control center, wherein the user is not participating in the additional program, and wherein the control center notifies the user of the additional program and provides the option for the user to participate in the additional program.

10. The system of claim 1 wherein the mobile device includes an NFC chip, wherein the mobile wallet includes a widget to interface with the control center, and wherein the mobile wallet employs an NFC protocol to transact electronic purchases of items with an NFC terminal of a retailer.

11. A system for use with:
a mobile device of a user; and
a mobile wallet stored on the mobile device and executed by the mobile device to transact electronic purchases of items, wherein the mobile wallet stores ereceipts of each purchase on the mobile device;
said system comprising:
a control center to implement at least one loyalty program of a partner;
a loyalty APP stored on the mobile device and executed by the mobile device to facilitate communication between the user and the control center via the mobile device, the loyalty APP to allow the user to coordinate the user's involvement in the loyalty program;
wherein the control center received ereceipts from the mobile wallet or from the loyalty APP;
wherein the control center evaluates the provided ereceipts to identify purchased items;
wherein the control center determines purchased items which quality under the loyalty program; and
wherein the control center implements the loyalty program in response to the qualified items.

12. The system of claim 11 wherein the purchased items which qualify under the loyalty program will have an associated action (e.g., discount, awarding of points, other marketing activities) and wherein the control center implements the associated action.

13. The system of claim 11 wherein the loyalty APP allows the user to coordinate the user's involvement in the loyalty program as follows:
authorizing the transfer of ereceipts from the mobile wallet to the control center;
allowing the user to join or withdraw from the loyalty program; and
allowing the user to check their status within the loyalty program.

14. The system of claim 11 wherein the control center implements a plurality of loyalty programs of a plurality of partners.

15. The system of claim 13 wherein the mobile device includes an NFC chip, wherein the mobile wallet includes a widget to interface with the control center, and wherein the mobile wallet employs an NFC protocol to transact electronic purchases of items with an NFC terminal of a retailer.

16. The system of claim 11 wherein the mobile wallet or the loyalty APP include an aggregation module storing the ereceipts and providing the ereceipts to the control center.

17. The system of claim 11 wherein the control center comprises at least one of the following:
a receipts database storing received ereceipts;
a product data of products which are part of the loyalty program;
a member database of members of the loyalty program;
a loyalty database of rules of the loyalty program;
a rationalized receipts database of received ereceipts which been rationalized;
a rationalization engine for rationalizing ereceipts;
a receipt decomposer for decomposing the ereceipts;
a management module for use by an administrator to manage the loyalty program;
a module interface for interfacing between a rationalized receipts database and the loyalty APP; and
a gateway for providing access to the control center by which the following have access: an administrator, the partner, the mobile wallet and the loyalty APP.

18. The system of claim 11 wherein the control center notifies the user of a new program and provides the option for the user to participate in the new program.

19. The system of claim 11 wherein the control center identifies an additional program for which the user qualifies based on one of the purchased items in one of the ereceipts provided to the control center, wherein the user is not participating in the additional program, and wherein the control center notifies the user of the additional program and provides the option for the user to participate in the additional program.

20. The system of claim 11 wherein the mobile device includes an NFC chip, wherein the mobile wallet includes a widget to interface with the control center, and wherein the mobile wallet employs an NFC protocol to transact electronic purchases of items with an NFC terminal of a retailer.

21. A mobile APP for use with:
a mobile device of a user;
a mobile wallet stored on the mobile device and executed by the mobile device to transact electronic purchases of items, wherein the mobile wallet stores ereceipts of each purchase on the mobile device; and
a control center to implement at least one loyalty program of a partner;
said mobile APP comprising:
a loyalty APP stored on the mobile device and executed by the mobile device to facilitate communication between the user and the control center via the mobile device, the loyalty APP to allow the user to coordinate the user's involvement in the loyalty program;
wherein the mobile wallet or the loyalty APP provides the stored ereceipts to the control center;
wherein the control center evaluates the provided ereceipts to identify purchased items;
wherein the control center determines purchased items which quality under the loyalty program; and
wherein the control center implements the loyalty program in response to the qualified items.

22. The system of claim 21 wherein the loyalty APP allows the user to coordinate the user's involvement in the loyalty program as follows:
authorizing the transfer of ereceipts from the mobile wallet to the control center;
allowing the user to join or withdraw from the loyalty program; and
allowing the user to check their status within the loyalty program.

23. The system of claim 21 wherein the mobile device includes an NFC chip, wherein the mobile wallet includes a widget to interface with the control center, and wherein the mobile wallet employs an NFC protocol to transact electronic purchases of items with an NFC terminal of a retailer.

24. The system of claim 21 wherein the mobile wallet or the loyalty APP include an aggregation module storing the ereceipts and providing the ereceipts to the control center.
